(19) United States
(12) Patent Application Publication
(10) Pub. No.: US 2012/0148977 A1
(43) Pub. Date: Jun. 14, 2012

(54) DENTAL IMPLANT DETECTOR

(75) Inventors: Mordechai SHAHAK, Ramat-Gan (IL); Dina COHEN, Ramat-Gan (IL)

(73) Assignees: Mordechai SHAHAK, Ramat-Gan (IL); Benjamin COHEN, Yahud (IL); Dina COHEN, Ramat-Gan (IL)

(21) Appl. No.: 13/301,767

(22) Filed: Nov. 21, 2011

(30) Foreign Application Priority Data
Dec. 13, 2010 (GB) GB1021067.2

(51) Int. Cl. A61C 19/04

(52) U.S. Cl. 433/27; 433/215

(57) ABSTRACT

A dental implant detector comprising an inductive sensor arranged to detect a position of a dental implant in a jaw within a specified range by applying a magnetic field to the surroundings of the inductive sensor; an ergonomic handle connected to the inductive sensor and arranged to allow positioning the inductive sensor at various positions near the jaw; and a control unit connected to the inductive sensor and arranged to allow defining the specified range by adjusting a strength of the magnetic field, and to indicate detections by the inductive sensor. The dental implant detector is arranged to allow detection of dental implants concealed by bone or gum overgrowth.

### BACKGROUND

1. Technical Field

The present invention relates to the field of dentistry, and more particularly, to implant detection.

2. Discussion of Related Art

After implantation, dental implants are overgrown by bone and gum, yet their location is needed for further treatment. Current detection and location methods still necessitate broad surgical operations for locating the implants exactly, surgical operations which are accompanied with tissue damage, patient suffering and a lengthening of the recovery process. Current methods include imaging, which however is difficult to map upon the actual jaw, especially in toothless jaws, and chirurgical stents which cost about 2-3 thousand us$ and sometimes difficult to place at the site of the operation, and encumber the surgical procedures.

### BRIEF SUMMARY

Embodiments of the present invention provide a dental implant detector comprising: an inductive sensor arranged to detect a position of a dental implant in a jaw within a specified range by applying a magnetic field to the surroundings of the inductive sensor; an ergonomic handle connected to the inductive sensor and arranged to allow positioning the inductive sensor at various positions near the jaw; and a control unit connected to the inductive sensor and arranged to allow defining the specified range by adjusting a strength of the magnetic field, and to indicate detections by the inductive sensor, wherein the dental implant detector is arranged to allow detection of dental implants concealed by bone or gum overgrowth.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIGS. 1 and 2 are high level schematic illustrations of a dental implant detector, according to some embodiments of the invention; and

FIG. 3 is a high level schematic flowchart of a dental implant detection method, according to some embodiments of the invention.

### DETAILED DESCRIPTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

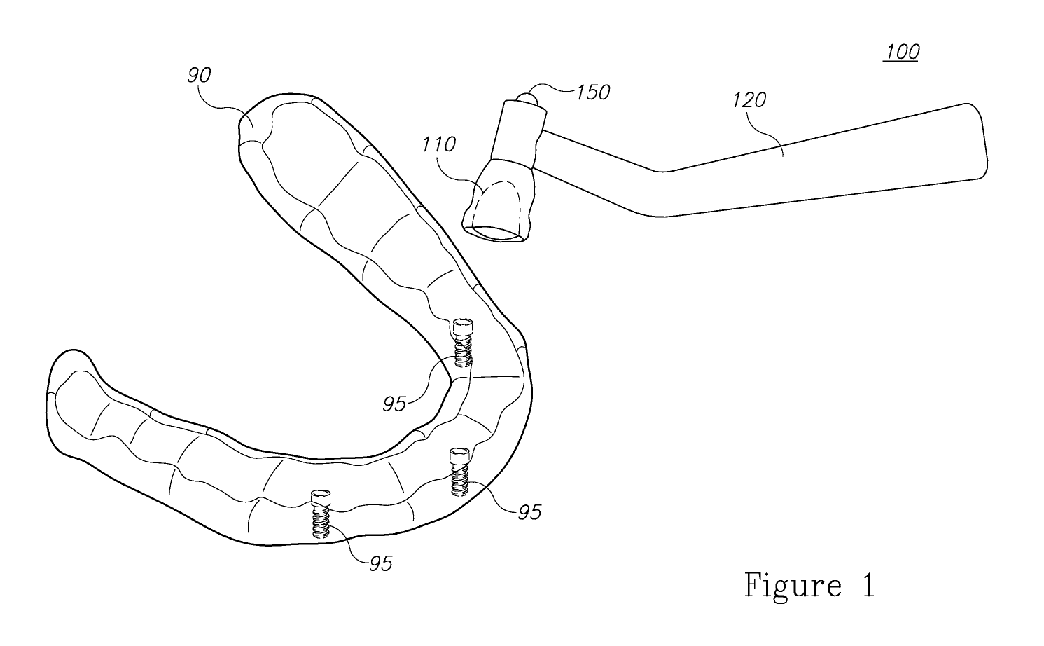

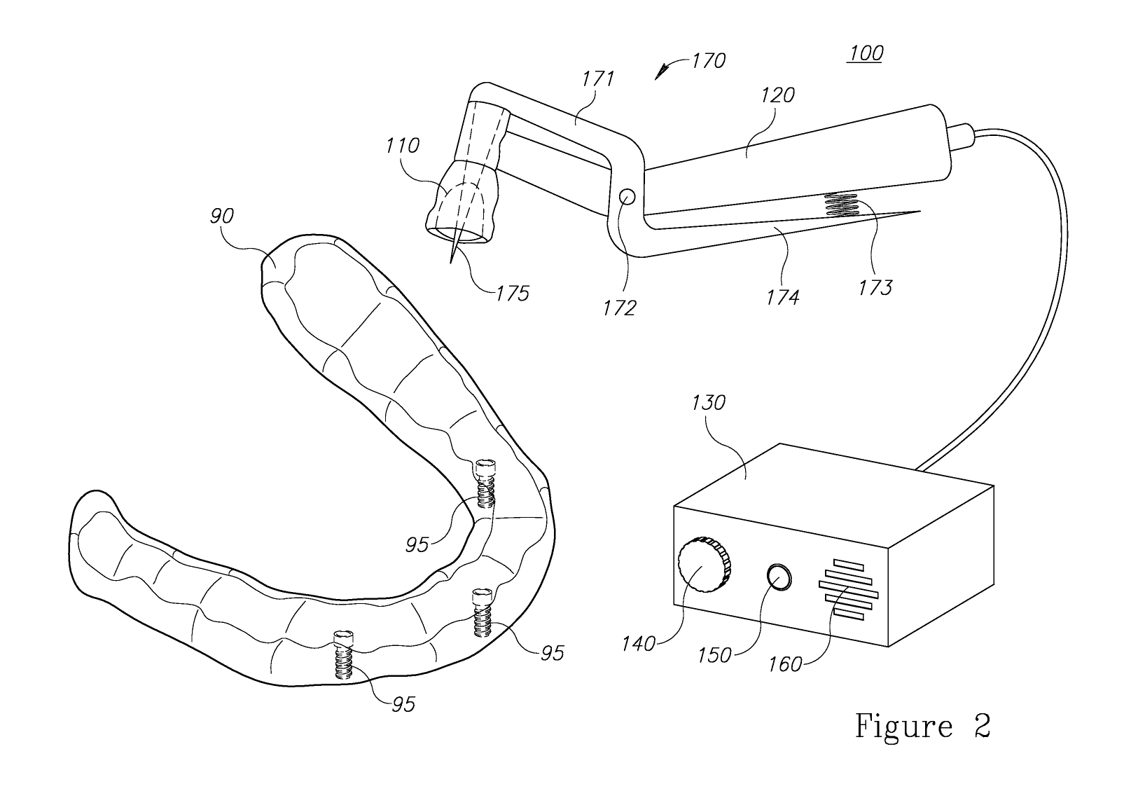

FIGS. 1 and 2 are high level schematic illustrations of a dental implant detector 100, according to some embodiments of the invention. Dental implant detector 100 detects and locates dental implants 95 concealed within a jaw 90 due to gum or bone overgrowth.

Dental implant detector 100 comprises an inductive sensor 110 attached upon or within an ergonomic handle 120 that is operated as an independent unit (FIG. 1) or connected to a control unit 130 (FIG. 2). Inductive sensor 110 is arranged to detect a position of dental implant 95 in jaw 90 within a specified range by applying a magnetic field to the surroundings of inductive sensor 110 and dental implant detector 100 has an indicator 150 arranged to indicate a specified proximity of implant 95 to sensor 110.

Inductive sensor 110 is operated by an electronic system, comprising an oscillator, demodulator, flip flop gate and an output circuit. In the independent version (FIG. 1) the electronic system and a battery are embedded in ergonomic handle 120.

Ergonomic handle 120 is arranged to allow easy positioning and movement of inductive sensor 110 at various positions near jaw 90 such as to allow the dentist exactly locate the concealed implants 95. Ergonomic handle 120 may be designed in a similar manner to handles of other dental devices, or include specific features that simplify implant location, such as optical or mechanical elements.

Ergonomic handle 120 is arranged to be operable by either hand, may have a texture for enhanced grasping, and be sterilizable. Ergonomic handle 120 may house some or all elements of control unit 130 (see below) or may accommodate wiring from inductive sensor 110 to control unit 130 either within or upon handle 120. Wiring may be accommodated in a slot in handle 120. Communication between inductive sensor 120 and control unit 130 may be wireless.

Control unit 130 is arranged to allow defining the specified range by adjusting a strength of the magnetic field, and to indicate detections by inductive sensor 110. The strength of the magnetic field maybe adjusted analogically (e.g. by a radio button) or digitally by a regulator 140, and control unit 130 may comprise electronics that allow automatic selection of a proper range according to readings, calibration possibilities, as well as a manual control of the range. The specified range allows detecting specific implants 95 and locate them at maximal precision, without interference of other implants 95 in jaw 90. Changing the specified range also allow the dentist to work in a search mode (looking for implants 95 over a wide jaw area) and a location mode (locating a specific implant 95 at high precision). Adjusting the strength of the magnetic field may be carried out by regulator 140 attached to ergonomic handle 120 for convenient operation.

Control unit 130 may further comprise indicator 150 such as a LED arranged to indicate a specified proximity of implant 95. For example, indicator 150 may change intensity, or may blink in a varying frequency according to the estimated distance to implant 95. Indicator 150 may be located upon ergonomic handle 120 to allow a convenient indication of implant proximity.

Control unit 130 may further comprise an audio indicator 160 such as a speaker arranged to indicate a specified proximity of implant 95. For example, audio indicator 160 may change intensity, frequency, or beep frequency according to the estimated distance to implant 95. Audio indicator 160 may be located upon ergonomic handle 120 to allow a convenient indication of implant proximity.

Dental implant detector 100 may further comprise a marking unit 170 associated with inductive sensor 110 and arranged to allow marking the detected position on gum 90. For example, marking unit 170 may be positioned coaxially around inductive sensor 110, or immerging from the center of inductive sensor 110, or in close proximity to inductive sensor 110 such that the marking is carried out exactly below inductive sensor 110.

As illustrated in FIG. 2, marking unit 170 may comprise a spike 175 for piercing the gum, connected via an arm 171, over a pivot 172 to a handle 174 that is operated by the user to mark the location of the detected dental implant 95. By pushing handle 174 (e.g. against a spring 173 arranged to return handle 174 and marking unit 170 to a resting state) at an implant location detected by inductive sensor 110, the location of implant 95 is immediately marked upon the gum itself, in a single action.

Marking unit 170 may also be applied independently of inductive sensor 110 and ergonomic handle 120 by a separate device, simultaneously with locating or shortly thereafter.

Marking unit 170 may mark the detected location of dental implant 95 in various methods, such as by ink, by attaching a marker to the gum, or by pricking the gum above dental implant 95.

Dental implant detector 100 allows detecting and locating dental implants 95 concealed within jaw 90 in a precision that allows further treatment with minimal damage to the gum and jaw 90. Thank to the high precision of dental implant detector 100 in respect to other methods, such as locating the implants with an imaging system (a method that suffers from inaccurate mapping of the image on jaw 90), or using the implantation template, implants 95 are found and used without an extended chirurgic operation of “excavating” them. Thus—operation damage and duration are minimized as are patient suffering, recovery time and the risk of infection.

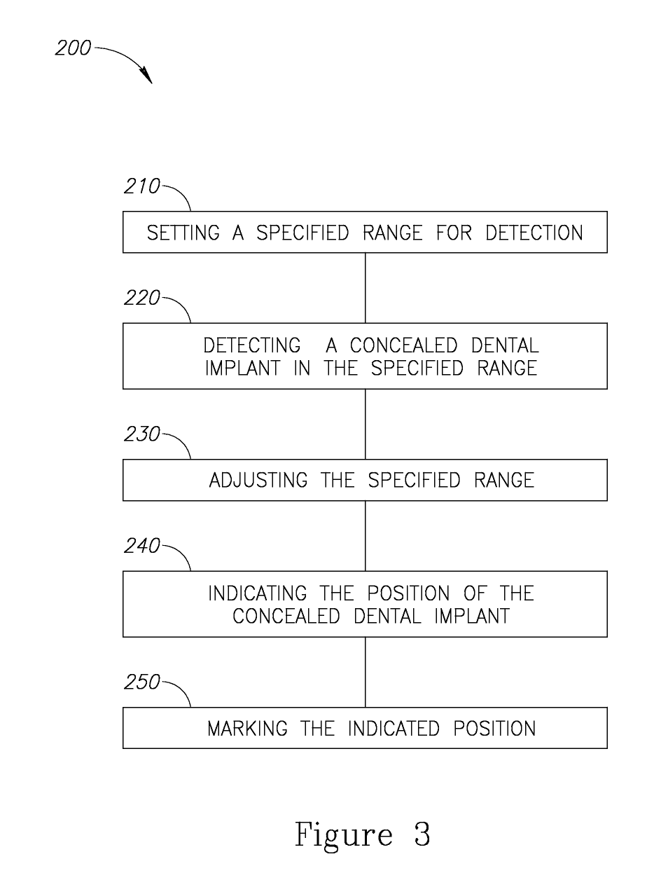

FIG. 3 is a high level schematic flowchart of a dental implant detection method 200, according to some embodiments of the invention. Method 200 comprises the following stages: setting a specified range for detection (stage 210); detecting, by induction, a concealed dental implant in the specified range (stage 220); adjusting the specified range (stage 230) to increase the location precision and determine a position of the concealed dental implant; and indicating the position of the concealed dental implant (stage 240). Method 200 allows detection of dental implants concealed by bone or gum overgrowth. Method 200 may further comprise marking the indicated position (stage 250).

In the above description, an embodiment is an example or implementation of the invention. The various appearances of “one embodiment”, “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Furthermore, it is to be understood that the invention can be carried out or practiced in various ways and that the invention can be implemented in embodiments other than the ones outlined in the description above.

The invention is not limited to those diagrams or to the corresponding descriptions. For example, flow need not move through each illustrated box or state, or in exactly the same order as illustrated and described.

Meanings of technical and scientific terms used herein are to be commonly understood as by one of ordinary skill in the art to which the invention belongs, unless otherwise defined.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

hat is claimed is:

1. A dental implant detector comprising:
an inductive sensor arranged to detect a position of a dental implant in a jaw within a specified range by applying a magnetic field to the surroundings of the inductive sensor;
an ergonomic handle connected to the inductive sensor and arranged to allow positioning the inductive sensor at various positions near the jaw; and
a control unit connected to the inductive sensor and arranged to allow defining the specified range by adjusting a strength of the magnetic field, and to indicate detections by the inductive sensor,
wherein the dental implant detector is arranged to allow detection of dental implants concealed by bone or gum overgrowth.

2. The dental implant detector of claim 1, further comprising a marking unit associated with the inductive sensor and arranged to allow marking the detected position on the gum.

3. The dental implant detector of claim 1, wherein the marking is carried out by pricking the gum above the dental implant.

4. A method comprising:
setting a specified range for detection;
detecting, by induction, a concealed dental implant in the specified range;
adjusting the specified range to increase the location precision and determine a position of the concealed dental implant; and
indicating the position of the concealed dental implant,
wherein the method allows detection of dental implants concealed by bone or gum overgrowth.

5. The method of claim 4, further comprising marking the indicated position.
